(19) United States
(12) Patent Application Publication
(10) Pub. No.: US 2025/0174368 A1
(43) Pub. Date: May 29, 2025

(54) QUANTUM MECHANICAL SYSTEM AND METHODS FOR CHANNEL STIMULATION AND EXTRACTION

(71) Applicant: GeV Gamma LLC, Orlando, FL (US)

(72) Inventor: Nelson YING, Lake Buena Vista, FL (US)

(21) Appl. No.: 18/843,747

(22) PCT Filed: Mar. 3, 2023
(86) PCT No.: PCT/US2023/063655

§ 371 Date: Sep. 4, 2024

Related U.S. Application Data
(60) Provisional application No. 63/316,507, filed on Mar. 4, 2022.

(51) Int. Cl. G21B 3/00

(52) U.S. Cl. CPC G21B 3/00

(57) ABSTRACT

The present invention comprises a novel quantum mechanical system and process for the stimulation and extraction of certain, particular transition state components. In various aspects, certain intermediate channels, out of an infinite number of equal-probability State B, can be probability-enhanced, and components extracted. Systems and methods implement quantum mechanical reactions transitioning from an initial State A to a final State C via an infinite number of equal-probability, intermediate, general State B channels. A subset of State B channels can be probability-enhanced via Ying Cell systems and methods and enable certain probability-enhanced State B channels to be exhibited upon detection.

### CROSS-REFERENCE TO RELATED APPLICATIONS

This application claims benefit under 35 U.S.C. § 119(e) of Provisional U.S. Patent Application No. 63/316,507, filed Mar. 4, 2022, the contents of which are incorporated herein by reference in their entirety.

### FIELD OF THE INVENTION

The present invention relates to the preparation of a quantum mechanical system and the stimulation and extraction of certain particular intermediate channels out of an infinite number of Feynman's Path Integral Formulation channels (“PIF”) or “transition states,” for processes going from State A, through an infinite number of intermediate State B channels, to State C, wherein, after a view-transformation from DView to PView, an extraction of certain particular State B channels are performed prior to, or essentially simultaneously with, the exhibition of any extracted states in the Human Sensory Space.

### BACKGROUND

Quantum Mechanics, formulated about a century ago, includes aspects that are substantially different from those of classical mechanics. Quantum Mechanics is essentially indeterministic, whereas classical mechanics is deterministic. There have been many different Interpretations of Quantum Mechanics, with the Copenhagen Interpretation being the one generally accepted and is often taught in schools. Feynman's Path Integral Formulation is another Interpretation in which there is an infinite number of equal-probability paths, aka intermediate channels, leading from State A through State B transition states (including those that involve virtual particle production and annihilation) and then to State C. However, most of these State B channels will not be exhibited or observed due to destructive interference at the point of observation. Neither Interpretation, for instance, can explain the successful experiments in certain fields such as D+D experiments and their daughter particles. Accordingly, technological applications and improvements for the stimulation and extraction of such State B channels are needed.

### BRIEF SUMMARY OF THE INVENTION

The present invention includes systems and methods for stimulating and extracting certain, particular transition states. In an exemplary aspect, systems and methods provide a Quantum Mechanical System (“QM System”). A Ying Cell system, as discussed herein, is a QM system. Aspects include a system for extracting certain, particular intermediate transition states and/or transition state components comprising: a sealable container comprising an electrolyte, an anode connected to the sealable container, a cathode connected to the sealable container, a power source connected to the anode and the cathode, an alpha source positioned inside the sealable container, a gamma (γ) source positioned outside (or alternately, positioned inside) the sealable container, a Faraday cage containing the sealable container, an insulating container containing the Faraday cage and sealable container, and a first pair of thermocouples positioned within the Faraday cage, and a second pair of thermocouples positioned outside of the sealable container.

In embodiments, the anode is a platinum rod, and the cathode is a palladium foil. The power source can be a reversible 15V direct current (DC) power source. The gamma source can be a ⁶⁰Co disk, such as a 1 microcurie ⁶⁰Co disk. The alpha source can be a ²¹⁰Po disk, such as a 0.1 microcurie ²¹⁰Po disk. Embodiments can further include a second pair of thermocouples positioned within the insulating container and a second pair positioned outside of the Faraday cage. The electrolyte can be deuterium oxide.

Embodiments can further include systems and methods for extracting helium and/or excess energy that has been generated, based on the QM Ying Cell system discussed above. Such methods can include: providing deuterium oxide within the sealable container, electrolyzing the deuterium oxide via the power source, and then to stimulate certain, particular transition states comprising helium+γ, and extracting helium and/or excess energy that has been generated, from the Ying Cell. Various embodiments can include applying a reverse voltage to the sealable container to re-stimulate transition of the deuterium oxide to helium+γ state. Additional embodiments can involve removing the alpha source to stop the transition from deuterium oxide to the helium and γ state. Similarly, the gamma source can be removed to stop the transition from deuterium oxide to the helium and γ state. Temperature can be tracked via the pair of thermocouples, and the power source can be adjusted, based on the temperature, to stimulate a desired amount of helium and/or excess generated energy, for extraction. In addition, electrolysis can occur for a period of time, e.g., hours, days, etc.

Accordingly, the QM System can a) be exhibited in a Probability View (“PView”), then b) an agent (e.g., a stimulation) can be applied to increase the probability of certain channels (e.g., certain, particular intermediate states) out of an infinite number of previously equal-probability channels. An intermediate state can be presently described herein as State B. Certain, particular intermediate states are channels, out of the original infinite number of channels in the Feynman's probability space, which when properly stimulated, have been extracted into “real space,” such that these particular channels, out an infinity of Feynman Path Integral Formulation (“PIF”) channels, are exhibited in HSS as certain, particular State B. As such, these exhibited/extracted channels would no longer be available for destructive interference when observed—where observation is generally a destruction or annihilation event. HSS is short for Human Sensory Space (i.e., a reality frame),

Systems and methods also provide the necessary conditions for a QM System initially in a Direct Particle View (“DView”) to be transformed into a Probability Wave View (“PView”). Accordingly, aspects of the present invention enable QM systems to be exhibited in the PView.

In additional aspects, once the QM system has been setup in the PView, an agent or stimulation can be applied to increase the probability of extraction of one or more particular channels from the infinite number of previously equal-probability Feynman PIF channels.

In various aspects, when an extraction is performed simultaneously with, or prior to, an observation or event, the observation or event can demonstrate that the extracted state is one of the State B transition states.

### BRIEF DESCRIPTION OF THE DRAWINGS

In the drawings, which are not necessarily drawn to scale, like numerals can describe similar components in different views. For example, numerals having different letter suffixes can represent different instances of similar components. The drawings illustrate generally, by way of example, but not by way of limitation, various aspects discussed in the present document. In the drawings:

FIG. 1 illustrates an example Ying Cell system, in accordance with embodiments discussed herein.

FIG. 2 illustrates a flowchart for channel component extraction, in accordance with embodiments discussed herein.

FIG. 3 illustrates a flowchart for channel stimulation, in accordance with embodiments discussed herein.

### DETAILED DESCRIPTION OF THE INVENTION

The Claimed Inventions are augmented below by a specific series of Process steps, which steps of said Process are as shown by prior experiments by the Inventor.

The terminology used herein is for the purpose of describing particular embodiments only and is not intended to be limiting of the invention. As used herein, the “and/or” include any and all combinations of one or more of the associated listed items. As used herein, the singular forms “a”, and “the” are intended to include plural form as well as the singular forms, unless the context clearly indicate otherwise. It will be further understood that the terms “comprises” and/or “comprising,” when used in this specification, specify the presence of states features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases, all of the other disclosed techniques. Accordingly, for the sake of clarity, this description will refrain from repeating every possible combination of the individual steps in an unnecessary fashion. Nevertheless, the specification and claim should be read with the understanding that such combinations are entirely within the scope of the invention and the claims.

New aspects of Quantum Mechanics, its interpretations, and applications thereof, are discussed herein. In the following description, for purposes of explanation, numerous specific details are set forth in order to provide a thorough understanding of the present invention. It will be evident, however, to one skilled in the art that the present invention can be practiced either without some of those specific details or with certain substitute details.

Aspects of the present invention include a) turning a QM system from a DView into a PView; and then b) the extraction of a particular class of intermediate channels from the infinite numbers of Feynman's Path Integral Formulation channels. It will be appreciated that embodiments are not limited by the process, or the process geometry, or the set ups used here for experiments or as examples.

Aspects of the present disclosure are to be considered as an exemplification of the invention and are not intended to limit the invention to the specific embodiments illustrated by the figures or description below.

Various embodiments discussed herein describe quantum mechanical systems to demonstrate probability enhanced of State B channels between a State A and State C. State A is demonstrated herein as an initial D+D state, certain particular State B channels are He+γ, and State C is a D+D final state. It can be demonstrated therefore that, while there can be an infinite number of equal probability paths or channels, within a transformation (e.g., State A to State C), certain channels (e.g., certain, particular State B channels) can be extracted.

Starting from basics, it has been shown that when a stream of electrons (the “Quantum System” or “QS”) is beamed at a target, a shadow pattern can be produced. However, when the experimental setup sends these electrons through one or more very small slits, one gets a diffraction or interference pattern, even when only one electron is released at a time.

The present invention demonstrates that raw electrons are exhibited in the Human Sensory Space (“HSS”), (i.e., a reality frame), as discrete particles, until they have had an experience. This is referred to herein as “Discrete View,” or alternately, shortened to “DView.” In the above slit example, the experience would be an electron traveling through the small slit and being “given a chance” to “make a choice” as to their travel path once having passed through the slit. This process can be described as going from a Discrete particle View (“DView”) in the Human Sensory Space into a Probability wave View (“PView”). This electron beam is then detected and annihilated at a screen, referred to as an “event” where a diffraction or interference pattern is observed. Accordingly, embodiments of the present invention demonstrate that a Quantum System (“QS”) can, a) via an experience, be re-exhibited from a DView to a PView; and b) while the Quantum System (“QS”) is in the PView, it is subjected to manipulation or stimulation.

As such, when a particular point, within its probability space is examined for a particular trait or feature, an interaction is required, and a value would be determined. However, examining a different point would return a different value. An interaction, which in principle can be measured, can be an interaction that involves a quantum object and is capable of also giving a definite value—irrespective of whether actually observed or not observed.

Embodiments of the present invention include transition state stimulation and extraction applications, which incorporate aspects of the quantum mechanical systems discussed above. An electrolysis setup can comprise using an anode (e.g., a platinum anode), and a cathode (e.g., a palladium cathode), within heavy water (D₂O). An Alpha (α) emitter and a Gamma (γ) emitter applied to the system generate heat rise. But heat rise stops when either (i) the α or γ emitter is removed; or (ii) when H₂O is substituted for the D₂O. The demonstration of heat rise indicates that an “experience” via, e.g., a γ application to the D+D system, and then an “event”, namely the stimulation via an α application to the D+D system, followed by observation, are sufficient. However, when any of these are removed, the heat rise stops” indicates the alpha application, gamma application, and deuterium oxide source are all necessary.

Deuterium particles directed to the cathode are referred to herein as being in the DView. The term DView is used for clarification purposes and not meant to limit or restrict embodiments or applications. The DView can be viewed similarly to electrons in the two-slit experiment when directed towards the slit, but prior to being given a choice by the experimental setup regarding “choosing” which slit to pass through. In the two-slit experiment, the PView would represent the probabilities of the infinite pathways that the electron could take. An experience (e.g., the electron passing through the two-slit film and/or having the option to choose to pass through the two-slit film) is required to transition the DView particles into PView.

The present systems and methods require, for the “experience”, as a minimum, the creation or annihilation of particles or quasi-particles, which need not involve the quantum mechanical system. In various embodiments, ⁶⁰CO can act as the gamma source for pair production (aka the “experience”) and thus transition from the DView into the PView. However, various types of gamma sources can be utilized. Applicable gamma sources provide sufficient energy for pair production. Then while in the PView, an alpha source, such as ²¹⁰Po, stimulates and increases the probability of emissions of alpha particles of various corresponding energies, thus extracting the previously equal-probability “He+γ” channels. Similar to the gamma source, alternate alpha sources can be utilized, and generally, any source to obtain the boson-boson interactions and stimulations discussed herein.

As such, Ying Cell embodiments discussed herein further demonstrate an experimental verification for the quantum mechanical particle generation, and improvements to the Copenhagen Interpretation. In particular, the Ying Cell provides emission stimulation and enables extraction of particular transition states (certain particular State B) between a State A and a State C.

### Ying Cell System, Process, and Experiments

Aspects of the present invention will now be described by referencing the appended figures representing preferred embodiment. In various embodiments and experiments, a quantum mechanical system was considered, wherein the system's initial State A is D+D, and whose final State C is also D+D, wherein deuterium are created via electrolysis of D₂O.

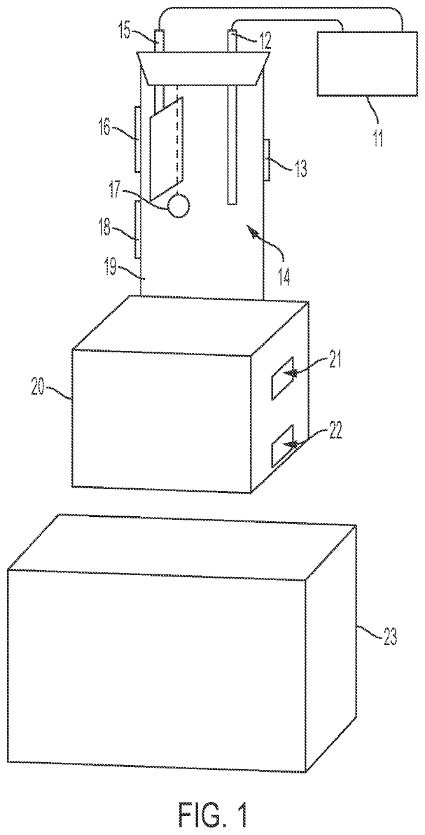

FIG. 1 depicts an exploded perspective view of a device comprising a Ying Cell 19, a Faraday cage 20, and an Insulating Container 23, according to various embodiments of the present invention. In various embodiments, the device can be configured with at least one power source 11. In embodiments, the power source can comprise a switchable, reversible 15V DC power source. Power can go to a first wire leading to an anode 12, such as a platinum (Pt) anode, and a second wire leading to a cathode 15, such as a palladium (Pd) cathode. The first and second wires, connected to respectively the anode and cathode, which can then connect to the Ying Cell 19. In various aspects, the Ying Cell can be a container, such as a sealable container, a beaker with stopper, and the like. The first and second wires, for example, can connect to the Ying Cell 19 via a stopper or seal on the Ying Cell 19. The Ying Cell 19 can further comprise holes for anode and cathode, or their connection wires (e.g., first and second wires) and an attachment to hold thread or wire, usable to hold an alpha source 17. In embodiments, the alpha source can be a ²¹⁰Po disk.

A gamma source 13 can attach to the outside of the Ying Cell 19. In examples, the gamma source can be a radioactive source, such as a ⁶⁰CO disk.

In various embodiments, the Ying Cell can be filled with an electrolyte 14, such as deuterium oxide (D₂O). Other electrolytes providing a deuterium source upon electrolysis can also be utilized with various examples and embodiments discussed herein.

At least two interior thermocouples 16, 18 can be placed on the outside of the Ying Cell. The Ying Cell and interior thermocouples 16, 18 can be placed inside a Faraday cage 20, and two or more exterior thermocouples 21 22 can be placed outside of this Faraday cage 20. The Faraday cage 20 blocks electromagnetic fields and various examples can include a covering of conductive material and/or a mesh covering of conductive material.

The Faraday cage 20 can then be placed inside an insulated container 23.

In various experiments implemented a QM Ying Cell system comprises an initial state, State A, an infinite number of intermediate State B, and a final State C. In embodiments, State A is “D+D”, and the final State C is also “D+D” where the Deuterons are created via electrolysis of D₂O, which together with all the other parts produces excess heats.

In various embodiments of the Ying Cell system, a Pt anode and a Pd cathode, with D₂O as electrolyte, connected to a 15V D.C. battery power-source. In various configurations, a Pd foil, such as a 2.5 cm×2.5 cm, 0.025 mm thick Pd foil, can be used. In various experiments, foils from both Johnson Matthey and Wilkinson were successfully tested in various Ying Cell constructions and embodiments. Applicable geometries can comprise a straight 1.0 mm diameter Pt as the anode. Four thermocouples can also be used. In an example, two thermocouples were taped to the exterior of the Ying Cell at different heights, and the other two thermocouples were placed outside of the Faraday cage 20 but within the insulated container. This thermocouple placement prevents incorrect readings due to potential hot spots.

In another example, the gamma source 13 was a 1 microcurie ⁶⁰Co disk from Sargent & Welch. The gamma source 13 can be taped to the outside of a beaker that was used in the Ying Cell system. The alpha source 17 was a 0.1 microcurie disk of ²¹⁰Po disk, placed inside the Ying Cell beaker, as close as possible to the Pd cathode without blocking the incoming deuterium (hereinafter “D”) to the cathode. The components were placed within a Faraday cage and then the entire apparatus, including the Faraday cage, was placed within an insulated container. After over-night “seasoning,” in which D “loading” occurs at the Pd interstitial sites, heat increase was noted. In various embodiments, deuterium oxide can be electrolyzed for a period of time (e.g., one, two, four, six, eight, ten hours, etc.) When the heat-increase ceased, it was found that applying a reverse voltage for a short time to the cell, and allowing it to reset overnight, would cause the cell to begin to react again. Such reaction is easily accomplished by swapping the anode and cathode leads. A 10 second reversal, and an optimal over-night reset, is usually sufficient to cause the cell to become operational again.

Additional electrolyte salt was not needed to be added to the heavy water. The signature heat rise in the Ying Cell stops upon the removal of either ⁶⁰Co or ²¹⁰Po, or the substitution of H₂O for D₂O. It will be appreciated that the present invention is not limited by the equipment, equipment geometries, or the placement thereof.

It was determined that, the State B channels, also referred to herein as Feynman infinite equal-probability paths or channels, are between the initial State A, D+D state, and State C, the general final D+D state. A subset of State B channels comprise the intermediate channels of “D+D→He+γ→D+D”, wherein different channels of this nature would have different energies for the He and γ. The Ds that are released by electrolysis of D₂O, are particles in the DView. The DView is analogous to the cases of photons or electrons beams when they are released, when they are not in the one-slit or two-slit experimental setup, especially when not being given an opportunity to later reach the slits, of 1-slit or 2-slit experiments.

In addition, it was noted that an experience is required to bring a QM system, if not already in the PView, from the DView into the PView. The experience can, at the minimum, be the creation or annihilation of a particle (or quasi-particle) (i) within a range that is in the order of the de Broglie wavelength of the initial or final QM system, and (ii) in which the creation or annihilation does not stem from and/or involve this QM system.

When an experiment is set up for D+D→X→D+D, wherein X is a State B transition state, the inclusion of a Gamma emitter, in which gammas are enough to create a “pair production” when in the region of a nuclei (e.g., a Pd nuclei), gives the necessary and sufficient condition for “an experience” as discussed herein. The experience can be that which, for the D+D QM system, transforms it from a DView into a PView. Such a transition, from a DView into a PView, if not performed, would cause the heat production in the Ying Cell to stop, as shown upon the removal of the gamma emitter (e.g., a disk of ⁶⁰CO).

When the QM system is in the PView, “D+D→He+γ→D+D” are some of the equal-probable paths or channels. In an embodiment, an alpha emitter, such as a ²¹⁰Po disk was placed within the D₂O, close to the cathode, so as to reduce collision-loss of alphas. The “initial-²¹⁰Po-decay-alphas” result in the emission of “stimulated-alphas” extracted from the “D+D→He+γ” path, and which emission thereby removed these channels from the infinite equal-probability paths. Such State B extracted channels then are no longer available to participate in the destructive interference at the observation/destruction point (aka “the event”).

Moreover, once said stimulated alpha is realized, the reaction also realized gamma. Accordingly, initial alphas are necessary for stimulating the extraction for this reaction. This is also why the heat production in the Ying Cell stops upon the removal of the alpha emitter (e.g., the disk of ²¹⁰Po).

Accordingly, the above experiments indicate that D is involved in the generation of heat production. In a similar experiment, in which H₂O was substituted for D₂O, the Ying Cell system also stopped heat production. Thus, heat rise in the Ying Cell system stops upon the removal of either the alpha source, the gamma source, or the substitution of the electrolyte, e.g., substituting H₂O for D₂O.

In as much as the extraction of He and γ from the State A→B reaction, (i.e., D+D→He+γ) involves the creation of He as well as γ. As such, two particles were created that involve the D+D QM system. Therefore, embodiments of the present invention generate an “event” which exhibits the transformation of State A (D+D) to certain, particular State B (He+γ) and enables extraction of at least one of He, or γ, or the excess energy that has been generated.

In the examples discussed above, because the Pd and gamma system can serve (as further described herein below) to balance the momentum of the stimulated alpha, neutrons are not necessary to conserve momentum.

In a metal, the positive ions are within an electron sea, and there is no Coulomb repulsion between the positive ions. However, there is metallic bonding, which is the electrostatic attraction between the metal atoms or ions and delocalized electrons. Therefore, there is no repulsion between the positive ions nor between the interstitial D and the incident D. As such, Coulomb repulsion of D and D might not be relevant within a metal.

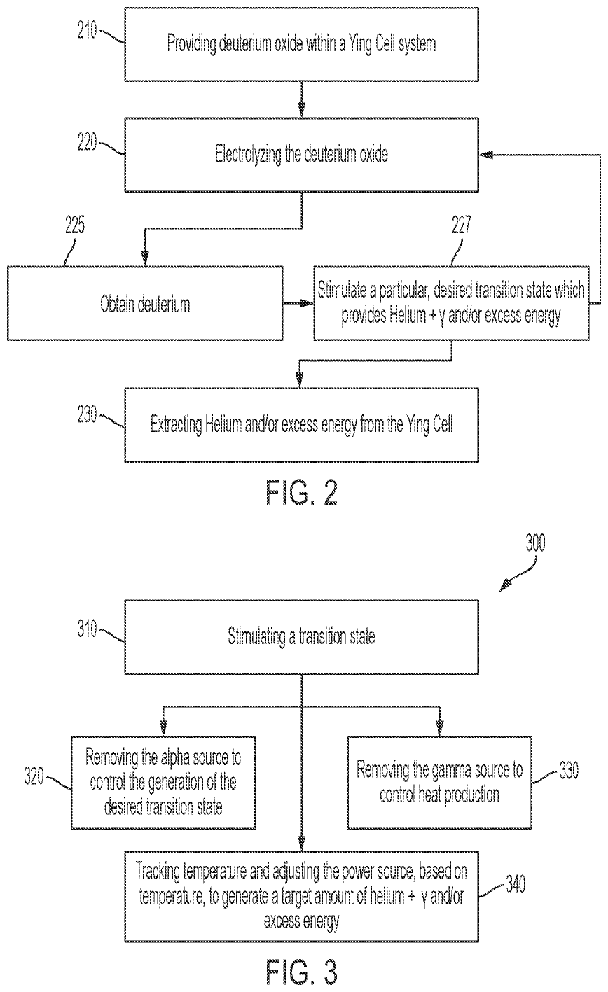

FIG. 2 illustrates a flowchart for an application of the systems and methods discussed herein. Embodiments enable extraction of a component of an electrolyte provided within the Ying Cell system of FIG. 1.

In examples, deuterium oxide (i.e., Heavy Water, aka D₂O) can be provided within a Ying Cell system 210. Deuterium oxide serves as the electrolyte from which deuterium can be extracted.

At block 220, the deuterium oxide undergoes electrolysis to provide deuterium, which upon (i) initially reaching and entering the Pd cathode's interstitial sites, and then (ii) with the later-arriving incident D, (iii) creates an initial transition State A=D+D; (and where the original final state C also=D+D).

In examples, given an electrolyte comprising deuterium oxide, after electrolysis and when the resulting Ds enters the Pd cathode, there is an infinite number of in-between states B (between State A and State C) which can comprise certain, particular channels He+γ. Electrolysis can occur for a period of time, e.g., overnight, a period of hours, days, etc., to create the Ds, which upon reaching the Pd cathode, as described above, creates an initial transition State A=D+D, with initial final State C also=D+D; and in examples, after transitioning from the DView to the PView due to an ‘experience’ provided by the ⁶⁰Co, and after the ‘extraction due to boson-boson interaction/stimulation by the alphas from ²¹⁰Po’, a desired amount or target amount of components, such as helium and/or excess energy, is generated.

At block 225, the electrolysis can obtain deuterium. At block 227, such actions (the incoming alpha from PO²¹⁰) can stimulate/create/extract a particular, desired transition state that corresponds to the incoming alpha from the PO²¹⁰ and thus provide He+γ and/or excess energy. Such excess energy can, if desired, be partially or fully utilized in the electrolysis at block 220. The flow chart continued to block 230 regarding any un-utilized He and/or excess energy

At block 230, He+γ and/or excess energy that is generated, can be extracted from the system. Helium and/or excess generated energy can be extracted from the system in any of a plurality of methods known to those of ordinary skill in the art. An extraction tube, for example, can be connected to the sealable container, to extract helium upon its generation. As discussed herein, the volume of helium and/or excess generated energy can be adjusted based on a change to one or more of the power source, the alpha source, and the gamma source.

In an example, after electrolysis of the heavy water, with Pd as the cathode and Pt as anode, D reaches the Pd cathode and occupies Pd's interstitial sites. Upon further electrolysis of heavy water, the system also produces D, with λ_{de Broglie} of about a fraction of an A°, incident upon the Pd (whose interstitial sites are now mostly filled with the earlier D) . . . leading to State A=D+D. The incident gammas from ⁶⁰CO, with energies of 1.173 or 1.332 MeV, are sufficient for pair production, which need not involve a quantum object. This pair-production creation can occur outside of a quantum object's Heisenberg Cut, but within a distance that is the quantum object's de Broglie wavelength, or the de Broglie wavelength of the created or destroyed particle (e.g., quasi-particle). This is referred to herein as “an experience.” As such, with this “experience,” within the HSS into which the quantum object's behavior is projected, the system-exhibition thereby transits from the DView into the PView; and thusly a probability-distribution is mapped for each of the attribute-sets that are capable of being exhibited in the HSS reality realm.

It further appears that when incident alpha particles from the alpha source arrive at the cathode, it is sufficient to effect stimulation of the desired transition states due to boson-boson interaction. These arriving incident alpha particles are of various energies due to a variation in their collisions history prior to reaching the individual quantum objects. When those incident alpha particles, with energy states corresponding to the energies of various probable alpha particles of a series of probable “D+D→He+γ” reactions, is within the reaction distance of said corresponding points, said incident alpha particles (of various energies) would perturb these corresponding states which have these same, or similar, energies and thus stimulate and increase the probability of, resulting in the production of, He+γ. These daughter particles then can go on and on and stimulate the production of additional next-generation daughters He+γ. Each of these can be referred to as an “event”—which is also a necessary condition. And when the alpha source is removed, the excess heat production also stops.

Neutron production is also not necessary, at least due in part to the solid state mode of present embodiments. In a solid, even though H, D, and He can drift, such drift velocity is slow, and thus the time is significantly longer than the time for State A→B, e.g., the D+D→He+γ reaction. Therefore, the effect might be comparable to a variation of the Mossbauer effect, which is seen in solids but not in gasses. It can also be postulated here that the entire Pd crystal can be considered to have participated and that momentum is conserved when the “daughter alpha particle” and the Pd “cathode+daughter γ” moves in a direction opposite to each other upon the creation of the daughter He+γ. Under this scenario, neutrons are not needed to conserve momentum.

Additionally, in a metal, the positive ions are within an electron sea, so there is no Coulomb repulsion between the positive ions. There can be metallic bonding, which is essentially electrostatic attraction between metal atoms/ions and delocalized electrons. Therefore, there is no repulsion between the positive ions; and no repulsion between the interstitial D and the incident D. Coulomb repulsion, which is said to keep the interstitial D and the incident D separated, might not be relevant within a metal. In another words, the positive ions (e.g., in this case, the interstitial Ds and the incident Ds) are within an electron sea, and thus they are not affected by any Coulomb repulsion.

Such above reasons can also indicate why no neutron is found within experiments that successfully resulted in the production of He, or γ, or excess-generated-energy, and why Coulomb repulsion between the incident D and interstitial D can be ignored. Moreover, both a gamma emitter and an alpha emitter are necessary, as the removal of either stops the reaction, and a D source is necessary, since replacing it with an H source, like water, stops the reaction.

Experiments further suggest that given the low penetration capability of alpha particles, e.g., from ²¹⁰Po decay, especially after multiple collision en route from the experiment's He source and the Pd cathode, that the above initial reactions occur mostly on the surface of the cathode. Therefore, a large surface-area cathode might better serve this purpose. Increasing the number of incident gammas and alphas might further scale up the resulting products, whereas increasing the electrolysis voltage so that the D has higher energy might be counterproductive. However, experiments of this nature can provide an optimal voltage. In addition, installing an auto-reversing-voltage-mechanism on a suitable timer-basis could assist in “refreshing” the cathode to allow for a more continuous production of resultant product, such as heat, etc.

In addition, it was noted that emitted alphas from ²¹⁰Po decay from the Sargent & Welch disk, especially after collisions en route to the Pd cathode, have low energy and therefore have long de Broglie wavelength. The range of energy of the alpha particles that finally reach the Pd target vary since it depends on the number of collisions of each alpha particle while on the way from the disk to the target. However, the energies would all be so low such that there would be essentially no penetration of the Pd target. Therefore, the anticipated interactions would, as mentioned earlier, be on the surface of the Pd.

It can also be assumed that the stimulated daughter alphas would also have energies of the order as the incident alphas. Thus, any initially produced daughter alpha that escapes from the Pd would most likely be towards the heavy water side because of the conservation of momentum, whereas the momentum of those produced/escaped daughter alphas would be balanced by the entire Pd cathode and the daughter γ recoiling in the opposite direction. Therefore, as mentioned above, thus neutron production would not be needed to conserve momentum at this stage.

Meanwhile, also as mentioned above, the y would be directed in the opposite direction, e.g., in the Pd direction, so that y energy could be dissipated by either pair production within the Pd, or turned into heat, or escape. Neutron production would also not be needed to conserve momentum at this stage.

In other words, an incident alpha, due, for example, to boson-boson interaction, can stimulate and bring into the HSS reality-space, He+γ, via D+D→He+γ, which in nature would be a very low probability reaction. However, with the consideration of Feynman's PIF, where all intermediate channels (aka States B) have equal probability, any probability enhancement via boson-boson interaction of certain particular intermediate channels would significantly increase their production as compared to all other intermediate channels. As such, that channel, and other similarly stimulated channels, are no longer available to participate in destructive interference within the total paths of State A→C, e.g., “D+D→D+D”.

Accordingly, as alluded to several times herein: an “experience’ effect the projection of the quantum object into the PView of the HSS. And when the quantum object is in the PView, a stimulation (e.g., boson-boson interaction) can sufficiently increase the probability of certain channels, increase it to beyond the previously Feynman's equal probability case for all intermediate channels, and thus an “event” (e.g., an observation or measurement) can affect the projection back into a particular state in DView in the HSS, and thereby exhibit this increase of the probability for a particular desired outcome.

FIG. 3 illustrates a flowchart for additional applications of the stimulated transition state 300, in accordance with various examples and embodiments discussed herein.

At block 310, a transition state (initially comprising a component of an electrolyte) can be stimulated via the Ying Cell system. In accordance with the above examples, the electrolyte can be deuterium oxide, and the stimulated/extracted transition state can be He+γ and/or excess-generated energy. The initial state and transition state can be manipulated and adjusted via changes to one or more of the power source, the D source, the alpha source, and the gamma source. As such, a volume of helium, and/or excess-generated energy, for example, can be generated for extraction or other application, using the various principles and concepts discussed herein.

At block 320, the alpha source is removed, to control the generation of the desired transition state. As discussed herein, the alpha source is necessary to stimulate the generation of the daughter “He+γ and/or excess-generated energy”. As such, a desired amount or target amount can be generated based on the alpha source's application or removal. For example, the alpha source can be removed for a period of time to, for example, to cease to generate, or to just generate the desired amount or target amount of, certain particular transition state, and the like.

At block 330, the gamma source is removed to control heat production. The gamma source is necessary to create an “experience” and allow the system to transition from the DView to the PView. The ‘removal’ is to reduce heat production. As such, a desired temperature or target temperature can be reached based on the gamma source's application or removal. For example, the gamma source can be removed for a period of time to, for example, to cease further generation, or to just generate the desired temperature or target temperature of the system, and the like.

At block 340, temperature can be tracked, and the power source can be adjusted, based on the temperature, to generate a target amount and/or desired amount of the certain particular transition state components. In various examples, this can be, initially, State A=D+D; and eventually, certain particular transition state components, e.g., “helium or γ and/or excess generated energy”) for extraction.

Any of a combination of applications or removals of one or more of the D source, alpha source, the gamma source, and the power source can be implemented to achieve the desired amount of certain particular transition states, and/or certain particular transition state components. In various examples one or more of the sources can be applied or removed for a period of time to stimulate a desired state. One or more of the state components can be extracted and applied to any of a variety and combination of applications.

### Aspects

The following Aspects are illustrative only and do not serve to limit the scope of the present disclosure or the appended claims.
Aspect 1. A system for stimulating the creation of transition state components and/or extracting transition state components, comprising: a sealable container comprising an electrolyte; an anode connected to the sealable container; a cathode connected to the sealable container; a power source connected to the anode and the cathode; an alpha source positioned inside the sealable container; a gamma source positioned outside or inside the sealable container; a Faraday cage containing the sealable container; an insulating container containing the Faraday cage and sealable container; and a first pair of thermocouples positioned within the Faraday cage, and a second pair of thermocouples positioned outside of the sealable container.
Aspect 2. The system of Aspect 1, wherein the anode is a platinum rod, and the cathode is a palladium foil.
Aspect 3. The system of any one of Aspects 1-2, wherein the power source is a reversible 15V direct current (DC) power source.
Aspect 4. The system of any one of Aspects 1-3, wherein the gamma source is a ⁶⁰Co disk.
Aspect 5. The system of Aspect 4, wherein the ⁶⁰Co disk is a 1 microcurie disk.
Aspect 6. The system of any one of Aspects 1-5, wherein the alpha source is a ²¹⁰Po disk.
Aspect 7. The system of Aspect 6, wherein the ²¹⁰Po disk is a 0.1 microcurie disk.
Aspect 8. The system of any one of Aspects 1-7, further comprising: a second pair of thermocouples positioned within the insulating container and outside of the Faraday cage.
Aspect 9. The system of any one of Aspects 1-8, wherein the electrolyte is deuterium oxide.
Aspect 10. A method for stimulating the creation of helium and/or excess-generated energy via the system of Aspect 1, comprising: providing deuterium oxide within the sealable container; electrolyzing the deuterium oxide via the power source to, within the Pd cathode, create/provide D+D, provide a path to transition a system from DView to PView, and while in the PView, extract via stimulation one or more of the desired intermediate transition channels state comprising helium+γ, and/or excess-generated energy.
Aspect 11. The method of Aspect 10, further comprising: applying a reverse voltage to the sealable container, to the cathode and the anode, to ‘cleanse and re-energize’ the system, so as to, once more, be able to stimulate at least one of: a transition of the deuterium oxide to helium+γ, or excess-generated energy.
Aspect 12. The method of any of Aspects 10-11, further comprising: removing the alpha source to stop transitioning the deuterium oxide to D+D, helium+γ, and/or excess-generated energy.
Aspect 13. The method of any of Aspects 10-12, further comprising: removing the gamma source to stop heat production.
Aspect 14. The method of any of Aspects 10-13, further comprising: tracking temperature via the pair of thermocouples; and adjusting the power source, based on the temperature, to stimulate a target amount of helium and/or excess-generated energy for extraction.
Aspect 15. The method of any of Aspects 10-15, wherein electrolyzing the deuterium occurs for a period of time.
Aspect 16. The method of any of Aspects 10-16, further comprising extracting helium and excess-generated energy from the system.

What is claimed:

1. A system for stimulating the creation of transition state components and/or extracting transition state components, comprising:
a sealable container comprising an electrolyte;
an anode connected to the sealable container;
a cathode connected to the sealable container;
a power source connected to the anode and the cathode;
an alpha source positioned inside the sealable container;
a gamma source positioned outside or inside the sealable container;
a Faraday cage containing the sealable container;
an insulating container containing the Faraday cage and sealable container; and
a first pair of thermocouples positioned within the Faraday cage, and a second pair of thermocouples positioned outside of the sealable container.

2. The system of claim 1, wherein the anode is a platinum rod, and the cathode is a palladium foil.

3. The system of claim 1, wherein the power source is a reversible 15V direct current (DC) power source.

4. The system of claim 1, wherein the gamma source is a ⁶⁰Co disk.

5. The system of claim 4, wherein the ⁶⁰Co disk is a 1 microcurie disk.

6. The system of claim 1, wherein the alpha source is a ²¹⁰Po disk.

7. The system of claim 6, wherein the ²¹⁰Po disk is a 0.1 microcurie disk.

8. The system of claim 1, further comprising: a second pair of thermocouples positioned within the insulating container and outside of the Faraday cage.

9. The system of claim 1, wherein the electrolyte is deuterium oxide.

10. A method for stimulating the creation of helium and/or excess-generated energy via the system of claim 1, comprising:
providing deuterium oxide within the sealable container;
electrolyzing the deuterium oxide via the power source to, within the Pd cathode:
create D+D; and/or
provide a path to transition a system from DView to PView, and while in the PView, extract via stimulation one or more of the desired intermediate transition channels state comprising helium+γ, and excess-generated energy.

11. The method of claim 10, further comprising:
applying a reverse voltage to the sealable container, to the cathode and to the anode, to ‘cleanse and re-energize the system so as to be able to, once again, stimulate at least one of: a transition of the deuterium oxide to helium+γ, or excess-generated energy.

12. The method of claim 10, further comprising:
removing the alpha source to stop transitioning the deuterium oxide to D+D, helium+γ, and/or excess-generated energy.

13. The method of claim 10, further comprising:
removing the gamma source to stop heat production.

14. The method of claim 10, further comprising:
tracking temperature via the pair of thermocouples; and
adjusting the power source, based on the temperature, to stimulate a target amount of helium and/or excess-generated energy for extraction.

15. The method of claim 10, wherein electrolyzing the deuterium oxide occurs for a period of time.

16. The method of claim 10, further comprising extracting helium and excess-generated energy from the system.
